(19) United States
(12) Patent Application Publication
(10) Pub. No.: US 2026/0290858 A1
(43) Pub. Date: Sep. 24, 2026

(54) TUBULAR STRUCTURE WITH LOW IONIC CONDUCTIVITY

(71) Applicant: ARKEMA FRANCE, Colombes (FR)

(72) Inventors: Marjorie MARCOURT, Serquigny (FR); Sébastien VAUTIER, Serquigny (FR); Antoine GOUPIL, Seoul (KR)

(73) Assignee: ARKEMA FRANCE, Colombes (FR)

(21) Appl. No.: 18/873,761

(22) PCT Filed: Jul. 6, 2023
(86) PCT No.: PCT/FR2023/051039

§ 371 Date: Dec. 11, 2024

(30) Foreign Application Priority Data
Jul. 7, 2022 (FR) FR2206953

(51) Int. Cl. H01M 8/04029; B32B 1/08; B32B 7/02; B32B 7/12; B32B 27/08; B32B 27/32; B32B 27/34

(52) U.S. Cl. CPC H01M 8/04029; B32B 1/08; B32B 7/02; B32B 7/12; B32B 27/08; B32B 27/32; B32B 27/322; B32B 27/34; B32B 2250/24; B32B 2307/202; B32B 2457/10

(57) ABSTRACT

The present invention relates to a single-layer or multilayer tubular structure for transporting a coolant, said tube being intended for fuel cell cooling, comprising at least one inner layer (I) comprising at least one thermoplastic polymer chosen from a polyolefin, a thermoplastic vulcanizate (TPV), a fluoropolymer, a polyphenylene sulfide (PPS) and a polyphthalamide (PPA), said coolant having a dielectric conductivity of less than 30 μS/cm, as determined after aging of said single-layer or multilayer tubular structure in contact with said coolant for 168 hours at 80° C.

The present invention relates to a single-layer or multilayer tubular structure for transporting a coolant, said tube being intended for fuel cell cooling.

### PRIOR ART

The fuel cell is an electrochemical generator of energy that makes it possible to directly convert the chemical energy of a fuel (hydrogen, for example) into electrical energy. Thermal control of this fuel cell is important in order to ensure a good yield and a good service life. Heat exchange via fluid remains the most efficient and the most economical system.

The heat-transfer fluid will circulate within the cells. The fluid must therefore be dielectric in order to not disrupt the performance of the fuel cell, or even deteriorate it. The fluid must also not contain any chemical elements (oligomer, additives) that could pollute the cells.

The tubular structure that will transport the coolant of the fuel cell must not alter said coolant, in particular its dielectric conductivity. It must not release oligomers and/or ions into said coolant either and it must have very good resistance to contact with the heat-transfer fluid.

Patent US2019/0285203A1 describes a tubular structure with five layers, and notably HDPE/binder/PA6/binder/HDPE, as a cooling pipe for a motor vehicle.

International application WO 2020/039356 describes lines having at least three layers TPV/PP/TPV (TPV: thermoplastic vulcanizate) for a motor vehicle, in particular a motor vehicle temperature control line for fluid temperature control and cooling media.

Application US2007148388A1 describes engine coolant lines containing at least two layers: an outer layer consisting of a polyamide composition and an inner layer consisting of a polypropylene composition, which contains at least 50% by weight of polypropylene, the polypropylene being a multiphase copolymer of propene and of ethene.

EP 3670172A1 describes a multilayer pipe comprising at least one inner layer consisting of polypropylene (PP) and at least one outer layer consisting of polyphthalamide (PPA).

However, neither the use of these pipes for fuel cell cooling, nor the dielectric conductivity aspect of the coolant transported by these pipes, nor the release of oligomers and/or of ions is disclosed by these pipes.

There is therefore the need to provide pipes that can be used for fuel cell cooling, are capable of transporting a coolant having a dielectric conductivity and do not release oligomers and/or ions into said coolant.

The present invention therefore relates to a single-layer or multilayer tubular structure for transporting a coolant, said tubular structure being intended for fuel cell cooling, comprising at least one inner layer (I) comprising at least one thermoplastic polymer chosen from a polyolefin, a thermoplastic vulcanizate (TPV), a fluoropolymer, a polyphenylene sulfide (PPS) and a polyphthalamide (PPA), said coolant having a dielectric conductivity of less than 30 μS/cm, as determined after aging of said single-layer or multilayer tubular structure in contact with said coolant for 168 hours at 80° C.

The Inventors have therefore unexpectedly found that a single-layer or multilayer tubular structure for transporting a coolant having a dielectric conductivity of less than 30 μS/cm and comprising at least one inner layer (I) comprising at least one thermoplastic polymer as defined above, enabled fuel cell cooling while avoiding the release of oligomers and/or of ions into said coolant.

Throughout the description, the expression “tubular structure” and the terms “tube” or “pipe” have the same meaning and may be used interchangeably.

Said coolant is any heat-transfer liquid, notably a coolant based on water and additives.

It is notably based on glycol water, in particular based on water with propylene glycol or ethylene glycol.

The electric or dielectric conductivity expressed in microsiemens per centimeter (μS/cm) characterizes the ability of a material or of a solution to let electrical charges move freely and therefore allow the passage of an electric current. It is measured on the coolant with magnetic stirring at ambient temperature, after aging of said single-layer or multilayer tubular structure in contact with said coolant for 168 hours at 80° C., by means of a calibrated conductivity meter with automatic temperature compensation (HORIBA LAQUA-EC220K model equipped with a HORIBA 3552 3G0E0042 probe).

### As Regards the Thermoplastic Polymer of the Inner Layer (I)

It is chosen from a polyolefin, a thermoplastic vulcanizate (TPV), a fluoropolymer, a polyphenylene sulfide (PPS) and a polyphthalamide (PPA).

According to the invention, the inner layer (I) consists essentially of polyolefin, of thermoplastic vulcanizate (TPV), of fluoropolymer, of polyphenylene sulfide (PPS) or of polyphthalamide (PPA). The inner layer (I) may notably also comprise additives or conventional additives in addition to said thermoplastic.

Among the additives, mention may notably be made of those chosen from a catalyst, an antioxidant, a heat stabilizer, a UV stabilizer, a light stabilizer, a lubricant, a filler, a plasticizer, a flame retardant, a nucleating agent, a dye, an electrically conductive agent, a thermally conductive agent, an impact modifier or a mixture of these.

The inner layer is appropriately composed of at least 90% by weight, preferably at least 92% by weight, more preferably at least 95% by weight and very preferably at least 98% by weight of polyolefin, of thermoplastic vulcanizate (TPV), of fluoropolymer, of polyphenylene sulfide (PPS) or of polyphthalamide (PPA).

### The Polyolefin

In one embodiment, the thermoplastic polymer of the inner layer (I) is a polyolefin chosen from nonfunctionalized polyolefins, functionalized polyolefins and a mixture of the two.

For simplification, the polyolefin has been denoted (B) and functionalized polyolefins (B1) and nonfunctionalized polyolefins (B2) have been described below.

A nonfunctionalized polyolefin (B2) is conventionally a homopolymer or copolymer of alpha-olefins or of diolefins, for instance ethylene, propylene, 1-butene, 1-octene or butadiene. By way of example, mention may be made of:
polyethylene homopolymers and copolymers, in particular LDPE, HDPE, LLDPE (linear low density polyethylene), VLDPE (very low density polyethylene) and metallocene polyethylene,
propylene homopolymers or copolymers,
ethylene/alpha-olefin, such as ethylene/propylene, copolymers, EPRs (abbreviation for ethylene propylene rubber) and ethylene/propylene/diene (EPDM),
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to be up to 40% by weight.

The functionalized polyolefin (B1) may be a polymer of alpha-olefins having reactive units (the functionalities); such reactive units are acid, anhydride or epoxy functions. By way of example, mention may be made of the preceding polyolefins (B2) grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals such as Zn, etc.), or else with carboxylic acid anhydrides, such as maleic anhydride. A functionalized polyolefin is, for example, a PE/EPR mixture, the weight ratio of which can vary within broad limits, for example between 40/60 and 90/10, said mixture being cografted with an anhydride, notably maleic anhydride, in a degree of grafting of, for example, from 0.01% to 5% by weight.

The functionalized polyolefin (B1) may be chosen from the following (co) polymers, grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin, such as ethylene/propylene, copolymers, EPRs (abbreviation for ethylene propylene rubber) and ethylene/propylene/diene (EPDM);
styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) may also be chosen from ethylene/propylene copolymers, predominant in propylene, grafted with maleic anhydride and then condensed with monoaminated polyamide (or a monoaminated polyamide oligomer) (products described in EP-A-0342066).

The functionalized polyolefin (B1) may also be a copolymer or terpolymer of at least the following units: (1) ethylene, (2)alkyl (meth)acrylate or saturated carboxylic acid vinyl ester and (3) anhydride such as maleic anhydride, or (meth)acrylic acid, or epoxy, such as glycidyl (meth)acrylate.

As examples of functionalized polyolefins of the latter type, mention may be made of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li.

The term “alkyl (meth)acrylate” in (B1) or (B2) denotes C1-C8 alkyl methacrylates and acrylates and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the above-mentioned polyolefins (B1) may also be crosslinked via any suitable process or agent (diepoxy, diacid, peroxide, etc.); the term “functionalized polyolefin” also includes mixtures of the above-mentioned polyolefins with a difunctional reagent such as diacid, dianhydride, diepoxy, etc. that is capable of reacting with these polyolefins, or mixtures of at least two functionalized polyolefins that can react with each other.

The above-mentioned copolymers, (B1) and (B2), may be copolymerized in random or block fashion and may have a linear or branched structure.

The molecular weight, the MFI index and the density of these polyolefins may also vary within a broad range, as those skilled in the art will appreciate. MFI is the abbreviation for the Melt Flow Index. It is measured according to the standard ASTM 1238.

Advantageously, the nonfunctionalized polyolefins (B2) are chosen from polypropylene homopolymers or copolymers and any ethylene homopolymer or copolymer of ethylene and of a comonomer of higher alpha-olefin type, such as butene, hexene, octene, or 4-methyl-1-pentene. Mention may be made, for example, of PPs, high density PEs, medium density PEs, linear low density PEs, low density PEs or very low density PEs. These polyethylenes are known to those skilled in the art as being produced according to a “radical” process, according to a “Ziegler” type catalysis or, more recently, according to a “metallocene” catalysis.

Advantageously, the functionalized polyolefins (B1) are chosen from any polymer comprising alpha-olefin units and units bearing polar reactive functions, such as epoxy, carboxylic acid or carboxylic acid anhydride functions. By way of example of such polymers, mention may be made of terpolymers of ethylene, of alkyl acrylate and of maleic anhydride or of glycidyl methacrylate, such as the Lotader® products (SK Functional Polymer), or polyolefins grafted with maleic anhydride, such as the Orevac® products (SK Functional Polymer), and also terpolymers of ethylene, of alkyl acrylate and of (meth)acrylic acid. Mention may also be made of polypropylene homopolymers or copolymers grafted with a carboxylic acid anhydride and then condensed with monoaminated polyamides or monoaminated polyamide oligomers.

In one embodiment, the polyolefin is nonfunctionalized.

Advantageously, the nonfunctionalized polyolefin is chosen from a polyethylene and a polypropylene, in particular a polyethylene, in particular a high-density polyethylene (HDPE).

### The Thermoplastic Vulcanizate

In another embodiment, the thermoplastic polymer of the inner layer (I) is a thermoplastic vulcanizate (TPV).

The thermoplastic vulcanizate (TPV) is a mechanical mixture of an olefinic thermoplastic polymer with a polyethylene or polypropylene matrix, in particular with a polypropylene matrix, and of a vulcanized elastomer such as a vulcanized PP/EPDM (ethylene propylene diene monomer) mixture.

### The Fluoropolymer

In one embodiment, said thermoplastic polymer of the inner layer (I) is a fluoropolymer.

The fluoropolymer is a polymer which has a fluorocarbon as the repeating unit.

It may consist of the following monomers: ethylene (E), propylene (P), vinyl fluoride (VF1), vinylidene fluoride (VDF or VF2), tetrafluoroethylene (TFE), hexafluoropropylene (HFP), perfluoropropyl vinyl ether (PPVE), perfluoromethyl vinyl ether (PMVE) and chlorotrifluoroethylene (CTFE): CFCl═CF₂.

In particular, the fluoropolymer is chosen from poly(vinylidene fluoride) (PVDF), polytetrafluoroethylene (PTFE), polychlorotrifluoroethylene (PCTFE), ethylene tetrafluoroethylene (ETFE), a terpolymer of tetrafluoroethylene, of ethylene, and of hexafluoropropylene (EFEP), a copolymer of tetrafluoroethylene and of perfluoroalkyl vinyl ether, and mixtures thereof, notably ethylene tetrafluoroethylene (ETFE).

### The Polyphenylene Sulfide (PPS)

In one embodiment, said thermoplastic polymer of the inner layer (I) is a polyphenylene sulfide (PPS).

Polyphenylene sulfide (PPS) is a heat-stable semicrystalline polymer.

### The Polyphthalamide (PPA)

In one embodiment, said thermoplastic polymer of the inner layer (I) is a polyphthalamide (PPA).

The nomenclature used to define the polyamides is described in the standard ISO 1874-1:2011, “Plastics—Polyamide (PA) moulding and extrusion materials—Part 1: Designation”, in particular on page 3 (Tables 1 and 2), and is well known to those skilled in the art.

The polyphthalamide may be a homopolyamide or a copolyamide.

When it is in the form of a homopolyamide, it is of formula XAr or MXDY.

XAr denotes a unit obtained from the polycondensation of a diamine X and of an aromatic dicarboxylic acid, the diamine X being C6-C36, preferentially C6-C18, preferentially C6-C12, more preferentially C10-C12.

The diamine may be linear or branched. Advantageously, it is linear.

Said at least one C6-C36 diamine X may be chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine X is C6-C18 and is chosen from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C6 to C12 diamine X is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, said at least one C6 to C12 diamine X is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine X used is a C10 to C12 diamine, in particular chosen from 1,10-decamethylenediamine, 1,11-undecamethylenediamine and 1,12-dodecamethylenediamine.

The aromatic dicarboxylic acid is advantageously chosen from terephthalic acid (denoted T), isophthalic acid (denoted I) and 2,6-naphthalenedicarboxylic acid (denoted N) or mixtures thereof; in particular it is chosen from terephthalic acid (denoted T), isophthalic acid (denoted I) or mixtures thereof.

MXDY denotes a unit obtained from the polycondensation of meta-xylylenediamine (MXD) and of at least one aliphatic dicarboxylic acid Y.

Said at least one C6 to C36 dicarboxylic acid Y may be chosen from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one dicarboxylic acid Y is a C6 to C18 dicarboxylic acid and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Y is a C6 to C12 dicarboxylic acid and is chosen from adipic acid, suberic acid, azelaic acid, sebacic acid, undecanedioic acid and dodecanedioic acid.

Advantageously, said at least one dicarboxylic acid Y is C10 to C12 dicarboxylic acid and is chosen from sebacic acid, undecanedioic acid and dodecanedioic acid.

When said semicrystalline aliphatic polyamide is obtained from the polycondensation of at least one diamine X with at least one dicarboxylic acid Y, it may therefore comprise a single diamine or several diamines and a single dicarboxylic acid or several dicarboxylic acids.

Advantageously, said semicrystalline aliphatic polyamide is obtained from the polycondensation of a single diamine X with a single dicarboxylic acid Y.

In particular, the polyphthalamide (PPA) is chosen from PAST, PA6T, PA9T, PA10T, PA11T, PA12T, MXD6, MXD10 and MXD12.

It should be noted that, throughout the description, the C9 diamine comprises a diamine unit, containing 60 mol % or more of a 1,9-nonanediamine unit and/or of a 2-methyl-1,8-octanediamine unit relative to all the C9 diamine units.

When it is in the form of a copolyamide, it is of formula:
PA11/10T, PA12/10T, PA11/12T, PA12/12T, PA610/10T, PA612/10T, PA1010/10T, PA1012/10T, PA1212/10T, PA610/12T, PA612/12T, PA1010/12T, PA 1012/12T and PA1212/12T, in particular PA11/10T and PA11/12T.

It is in particular of formula X/YAr, as described in EP1505099, notably a semiaromatic polyamide of formula A/XT in which A is chosen from a unit obtained from an amino acid, a unit obtained from a lactam and a unit corresponding to the formula (Ca diamine). (Cb diacid), with a representing the number of carbon atoms of the diamine and b representing the number of carbon atoms of the diacid, a and b each being between 4 and 36, advantageously between 9 and 18, the (Ca diamine) unit being chosen from linear or branched aliphatic diamines, cycloaliphatic diamines and alkylaromatic diamines and the (Cb diacid) unit being chosen from linear or branched aliphatic diacids, cycloaliphatic diacids and aromatic diacids;

X.T denotes a unit obtained from the polycondensation of a Cx diamine and of terephthalic acid, with x representing the number of carbon atoms of the Cx diamine, x being between 6 and 36, advantageously between 9 and 18, notably a polyamide of formula A/5T, A/6T, A/9T, A/10T, A/11T or A/12T, A being as defined above, in particular a polyamide chosen from a PA 5T/10T, a PA11/10T, a PA MPMDT/6T, a PA MXDT/6T, a PA MXDT/10T, a PA MPMDT/10T, a PA BACT/6T, a PA BACT/10T, a PA 11/BACT, a PA 11/6T/10T, PA BACT/10T/6T, a PA 11/BACT/6T, PA 11/MPMDT/6T, PA 11/MPMDT/10T, PA 11/BACT/10T, a PA 11/MXDT/6T, a PA 11/MXDT/10T and a 11/5T/10T.

T corresponds to terephthalic acid, MXD corresponds to m-xylylenediamine, MPMD corresponds to methylpentamethylenediamine and BAC corresponds to bis(aminomethyl)cyclohexane.

In particular, said thermoplastic polymer of the inner layer (I) is a polyphthalamide (PPA) chosen from PA9T, PA6T, PA11/10T, PA12/10T, PA11/12T, PA 12/12T, PA610/10T, PA612/10T, PA1010/10T, PA1012/10T, PA1212/10T, PA610/12T, PA612/12T, PA1010/12T, PA 1012/12T and PA1212/12T, in particular PA11/10T and PA11/12T.

### As Regards the Structure Per Se.

The tubular structure of the invention may be single-layer or multilayer and it is used for transporting a coolant, and said tube being intended for fuel cell cooling.

Whether it is single-layer or multilayer, it comprises at least one layer (I) which comprises at least one thermoplastic polymer chosen from a polyolefin, a thermoplastic vulcanizate (TPV), a fluoropolymer, a polyphenylene sulfide (PPS) and a polyphthalamide (PPA), and said coolant having a dielectric conductivity of less than 30 μS/cm, as determined after aging of said single-layer or multilayer tubular structure in contact with said coolant for 168 hours at 80° C.

In one embodiment, it comprises at least one layer (I) which comprises at least one thermoplastic polymer chosen from a nonfunctionalized polyolefin, a thermoplastic vulcanizate (TPV), a fluoropolymer, a polyphenylene sulfide (PPS) and a polyphthalamide (PPA), and said coolant having a dielectric conductivity of less than 30 μS/cm, as determined after aging of said single-layer or multilayer tubular structure in contact with said coolant for 168 hours at 80° C.

In one embodiment, it comprises at least one layer (I) which comprises at least one thermoplastic polymer chosen from a nonfunctionalized polyolefin, a thermoplastic vulcanizate (TPV), a fluoropolymer chosen from ETFE, a polyphenylene sulfide (PPS) and a polyphthalamide (PPA), and said coolant having a dielectric conductivity of less than 30 μS/cm, as determined after aging of said single-layer or multilayer tubular structure in contact with said coolant for 168 hours at 80° C.

In another embodiment, it comprises at least one layer (I) which comprises at least one thermoplastic polymer chosen from a nonfunctionalized polyolefin, a thermoplastic vulcanizate (TPV), a polyphenylene sulfide (PPS) and a polyphthalamide (PPA), and said coolant having a dielectric conductivity of less than 30 μS/cm, as determined after aging of said single-layer or multilayer tubular structure in contact with said coolant for 168 hours at 80° C.

In a first variant, said structure is single-layer and the layer (I) is therefore in contact with the coolant.

In a second variant, said structure is multilayer and the layer (I) is therefore the inner layer that is in contact with the coolant.

In one embodiment of this second variant, said structure is multilayer and it comprises an outer layer (II) comprising at least one thermoplastic polymer, in particular a polyamide.

In one embodiment, said structure is multilayer and it comprises an outer layer (II) consisting of at least one thermoplastic polymer, in particular a polyamide.

Advantageously, said structure is two-layer and therefore consists, from the outside toward the inside, of the layers (II)//(I).

Advantageously, said inner layer (I) consists of at least said one thermoplastic polymer chosen from a polyolefin, a thermoplastic vulcanizate (TPV), a fluoropolymer, a polyphenylene sulfide (PPS) and a polyphthalamide (PPA).

Advantageously, said outer layer (II) consists of at least said one thermoplastic polymer, in particular a polyamide.

Advantageously, said inner layer (I) consists of at least said one thermoplastic polymer chosen from a polyolefin, a thermoplastic vulcanizate (TPV), a fluoropolymer, a polyphenylene sulfide (PPS) and a polyphthalamide (PPA) and said outer layer (II) consists of at least said one thermoplastic polymer, in particular a polyamide.

The outer layer (II) may notably also comprise additives or conventional additives in addition to said thermoplastic.

Among the additives, mention may notably be made of those chosen from a catalyst, an antioxidant, a heat stabilizer, a UV stabilizer, a light stabilizer, a lubricant, a filler, a plasticizer, a flame retardant, a nucleating agent, a dye, an electrically conductive agent, a thermally conductive agent, an impact modifier or a mixture of these.

The outer layer (II) is appropriately composed of at least 90% by weight, preferably at least 92% by weight, more preferably at least 95% by weight and very preferably at least 98% by weight of thermoplastic polymer, in particular a polyamide.

In one embodiment, said tubular structure releases an amount of ions into said coolant of less than or equal to 700 mg/kg of ions, more particularly less than or equal to 500 mg/kg, in particular less than or equal to 300 mg/kg, notably less than or equal to 100 mg/kg, the amount of ions released being determined on an 8×1 mm² single-layer tube by inductively coupled plasma mass spectrometry (ICP-MS) or by ion chromatography comprising said coolant.

### As Regards the Polyamide of the Outer Layer (II)

The polyamide (PA) may be a homopolyamide or a copolyamide or a mixture of these.

Advantageously, the polyamide is chosen from semicrystalline aliphatic polyamides, cycloaliphatic polyamides, and semiaromatic polyamides (polyphthalamides or PPA).

In particular, the polyamide of the layer (II) is chosen from a semicrystalline aliphatic polyamide having a mean number of carbon atoms per nitrogen atom of from C4 to C15 and a semiaromatic polyamide (PPA).

### The Semicrystalline Aliphatic Polyamide of the Outer Layer (II)

“Semicrystalline polyamide” is understood to mean a material which is generally solid at ambient temperature and which softens during a temperature increase, in particular after passing its glass transition temperature (Tg), and which can melt sharply when passing its so-called melting temperature (Tm), and which becomes solid again when the temperature decreases below its crystallization temperature.

The Tg, the Tc and the Tm are determined by differential scanning calorimetry (DSC) according to the standards 11357-2:2013 and 11357-3:2013 respectively.

The number-average molecular mass Mn of said semicrystalline polyamide is preferably in a range extending from 10 000 to 85 000, notably from 10 000 to 60 000, preferentially from 10 000 to 50 000, even more preferentially from 12 000 to 50 000. These Mn values can correspond to inherent viscosities of greater than or equal to 0.8, as determined in m-cresol according to the standard ISO 307:2007 but changing the solvent (use of m-cresol in place of sulfuric acid and the temperature being 20° C.).

The nomenclature used to define the polyamides is described in the standard ISO 1874-1:2011, “Plastics—Polyamide (PA) moulding and extrusion materials—Part 1: Designation”, in particular on page 3 (tables 1 and 2), and is well known to those skilled in the art.

The term polyamide embraces both homopolyamides and copolyamides.

Said at least one semicrystalline aliphatic polyamide is obtained from the polycondensation of at least one lactam, or from the polycondensation of at least one amino acid, or from the polycondensation of at least one diamine X with at least one dicarboxylic acid Y or mixtures thereof.

When said at least one semicrystalline aliphatic polyamide is obtained from the polycondensation of at least one lactam, said at least one lactam may be chosen from a C8 to C18, preferentially C10 to C18, more preferentially C10 to C12, lactam. A C8 to C18 lactam is notably decanolactam, undecanolactam and lauryllactam.

When said at least one semicrystalline aliphatic polyamide is obtained from the polycondensation of at least one lactam, it may therefore comprise a single lactam or several lactams.

Advantageously, said at least one semicrystalline aliphatic polyamide is obtained from the polycondensation of a single lactam and said lactam is chosen from lauryllactam and undecanolactam, advantageously lauryllactam.

When said at least one semicrystalline aliphatic polyamide is obtained from the polycondensation of at least one amino acid, said at least one amino acid may be chosen from a C8 to C18, preferentially C10 to C18, more preferentially C10 to C12, amino acid.

A C8 to C18 amino acid is notably 9-aminononanoic acid, 10-aminodecanoic acid, 10-aminoundecanoic acid, 12-aminododecanoic acid and 11-aminoundecanoic acid, as well as derivatives thereof, notably N-heptyl-11-aminoundecanoic acid.

When said at least one semicrystalline aliphatic polyamide is obtained from the polycondensation of at least one amino acid, it may therefore comprise a single amino acid or several amino acids.

Advantageously, said semicrystalline aliphatic polyamide is obtained from the polycondensation of a single amino acid and said amino acid is chosen from 10-aminodecanoic acid, 11-aminoundecanoic acid and 12-aminododecanoic acid, advantageously 11-aminoundecanoic acid.

When said at least one semicrystalline aliphatic polyamide is obtained from the polycondensation of at least one diamine X with at least one aliphatic dicarboxylic acid Y, the diamine X may be as defined above and the aliphatic diacid Y may be as defined above.

In one embodiment, the polyamide of the layer (II) is chosen from a semicrystalline aliphatic polyamide having a mean number of carbon atoms per nitrogen atom of from C4 to C15 and a semiaromatic polyamide (PPA).

In particular, the polyamide of the layer (II) is a semicrystalline aliphatic polyamide that has a mean number of carbon atoms per nitrogen atom of from C8 to C15, in particular from C9 to C15, notably from C10 to 15.

Notably, the semicrystalline aliphatic polyamide of the layer (II) is chosen from PA610, PA612, PA614, PA618, PA1010, PA1012, PA1014, PA1018, PA1210, PA1212, PA1214, PA1218, PA11 and PA12, in particular PA612, PA614, PA618, PA1010, PA1012, PA1014, PA1018, PA1210, PA1212, PA1214, PA1218, PA11 and PA12, notably PA614, PA618, PA1010, PA1012, PA1014, PA1018, PA1210, PA1212, PA1214, PA1218, PA11 and PA12.

Advantageously, the semicrystalline aliphatic polyamide of the layer (II) is chosen from PA11 and PA12.

### The Semiaromatic Polyamide of the Outer Layer (II)

It is as defined for the PPA of the inner layer (I).

In another embodiment of this second variant, said structure is multilayer and it comprises an outer layer (II) comprising at least one thermoplastic polymer, in particular a polyamide, and a binder layer (III) located between said inner layer (I) and said outer layer (II).

Advantageously, said structure is three-layer and therefore consists, from the outside toward the inside, of the layers (II)//binder//(I).

Advantageously, said inner layer (I) consists of at least said one thermoplastic polymer chosen from a polyolefin, a thermoplastic vulcanizate (TPV), a fluoropolymer, a polyphenylene sulfide (PPS) and a polyphthalamide (PPA).

Advantageously, said outer layer (II) consists of at least said one thermoplastic polymer, in particular a polyamide.

Advantageously, said inner layer (I) consists of at least said one thermoplastic polymer chosen from a polyolefin, a thermoplastic vulcanizate (TPV), a fluoropolymer, a polyphenylene sulfide (PPS) and a polyphthalamide (PPA) and said outer layer (II) consists of at least said one thermoplastic polymer, in particular a polyamide.

In one embodiment of this second variant and of its embodiments, the inner layer (I) has a thickness representing from 5% to 95% of the total thickness of said structure.

In another embodiment of this second variant and of its embodiments, the outer layer (II) has a thickness of at least 5% of the total thickness of said structure.

In yet another embodiment of this second variant and of its embodiments, the inner layer (I) has a thickness of from 5% to 95% of the total thickness of said structure and the outer layer (II) has a thickness of at least 5% of the total thickness of said structure.

### As Regards the Binder Layer

Said binder layer may comprise a binder as described, in particular, in patents EP 1452307 and EP 1162061, EP 1216826 and EP 0428833.

It is implicit that the layers (II) and (binder) or (I) and (binder) adhere to one another. The binder layer is intended to be interposed between two layers that do not adhere to one another or that adhere to one another with difficulty.

The binder may be, for example, but without being limited thereto, a composition based on 50% of copolyamide 6/12 (of 70/30 ratio by mass) of Mn 16 000 and on 50% of copolyamide 6/12 (of 30/70 ratio by mass) of Mn 16 000, a composition based on PP (polypropylene) grafted with maleic anhydride, known under the name Admer® QF551A from Mitsui, a composition based on PA610 (of Mn 30 000, and as defined elsewhere) and on 36% of PA6 (of Mn 28 000) and on 1.2% of organic stabilizers (consisting of 0.8% of phenol Lowinox® 44B25 from Great Lakes, of 0.2% of phosphite Irgafos® 168 from BASF, and of 0.2% of UV stabilizer Tinuvin® 312 from BASF), a composition based on PA612 (of Mn 29 000, and as defined elsewhere) and on 36% of PA6 (of Mn 28 000, and as defined elsewhere) and on 1.2% of organic stabilizers (consisting of 0.8% of phenol Lowinox® 44B25 from Great Lakes, of 0.2% of phosphite Irgafos® 168 from BASF and of 0.2% of UV stabilizer Tinuvin® 312 from BASF), a composition based on PA610 (of Mn 30 000, and as defined elsewhere) and on 36% of PA12 (of Mn 35 000, and as defined elsewhere) and on 1.2% of organic stabilizers (consisting of 0.8% of phenol Lowinox® 44B25 from Great Lakes, of 0.2% of phosphite Irgafos® 168 from BASF and of 0.2% of UV stabilizer Tinuvin® 312 from BASF), a composition based on 40% of PA6 (of Mn 28 000, and as defined elsewhere), on 40% of PA12 (of Mn 35 000, and as defined elsewhere) and on 20% of functionalized EPR Exxelor® VA1801 (Exxon), and on 1.2% of organic stabilizers (consisting of 0.8% of phenol Lowinox® 44B25 from Great Lakes, of 0.2% of phosphite Irgafos® 168 from BASF and of 0.2% of UV stabilizer Tinuvin® 312 from BASF), or else a composition based on 40% of PA6.10 (of Mn 30 000, and as defined elsewhere), on 40% of PA6 (of Mn 28 000, and as defined elsewhere) and on 20% of impact modifier of ethylene/ethyl acrylate/anhydride type in a 68.5/30/1.5 mass ratio (MFI 6 at 190° C. under 2.16 kg), and on 1.2% of organic stabilizers (consisting of 0.8% of phenol Lowinox® 44B25 from Great Lakes, of 0.2% of phosphite Irgafos® 168 from BASF and of 0.2% of UV stabilizer Tinuvin® 312 from BASF).

It is quite obvious that the multilayer tubular structure of the invention could comprise other layers, provided that the layer (I) is always the inner layer and that the layer (II) is always the outer layer and that there is adhesion between the various layers.

For example, it is possible to imagine a structure of type (from the outside toward the inside):

$$( II ) // binder // PA // binder // ( I ) .$$

Whatever the tubular structure described above, said tubular structure has an amount of soluble and insoluble extractables released into said coolant of less than 1 g/m², after aging of said multilayer tubular structure in contact with said coolant for 1200 hours at 80° C.

According to another aspect, the present invention relates to a tubular structure as defined above, for fuel cell cooling.

All of the characteristics defined for the structure are valid for the use thereof.

### EXAMPLES

The invention will now be described in greater detail by means of the following examples, which are not limiting.

The following structures were prepared by extrusion:

The multilayer tubes are produced by coextrusion. Use is made of a McNeil industrial multilayer extrusion line, equipped with five extruders connected to a multilayer extrusion head with spiral mandrels.

The screws used are single extrusion screws having screw profiles suited to polyamides. In addition to the five extruders and the multilayer extrusion head, the extrusion line comprises:
a die-punch assembly, located at the end of the coextrusion head; the inner diameter of the die and the outer diameter of the punch are chosen as a function of the structure to be produced and of the materials of which it is composed, and also of the dimensions of the tube and of the line speed;
a vacuum tank with an adjustable level of vacuum. Water maintained in general at 20° C. circulates in this tank, into which water is immersed a gauge for conforming the tube into its final dimensions. The diameter of the gauge is adapted to the dimensions of the tube to be produced, typically from 8.5 to 10 mm for a tube with an outer diameter of 8 mm and a thickness of 1 mm;
a succession of cooling tanks in which water is maintained at about 20° C., for cooling the tube along the path from the head to the drawing bench;
a diameter measurer;
a drawing bench.

The configuration with five extruders is used to produce tubes ranging from two layers to five layers. In the case of the structures in which the number of layers is less than five, several extruders are then fed with the same material.

In the case of the structures comprising six layers, an additional extruder is connected and a spiral mandrel is added to the existing head, with a view to producing the inner layer, in contact with the fluid.

Before the tests, in order to ensure the best properties for the tube and a good extrusion quality, it is verified that the extruded materials have a residual moisture content before extrusion of less than 0.08%. If this is not the case, an additional step of drying the material before the tests is performed, generally in a vacuum dryer, overnight at 80° C.

The tubes, which meet the characteristics described in the present patent application, were taken, after stabilization of the extrusion parameters, the target dimensions of the tube no longer changing over time. The diameter is monitored by a laser diameter measurer installed at the end of the line.

Generally, the line speed is typically 20 m/min. It generally varies between 5 and 100 m/min.

The screw speed of the extruders depends on the thickness of the layer and on the diameter of the screw, as is known to those skilled in the art.

In general, the temperatures of the extruders and of the tools (head and connector) should be set so as to be sufficiently higher than the melting temperature of the compositions under consideration, so that they remain in the molten state, thus preventing them from solidifying and blocking the machine.

The tubular structures were tested with regard to various parameters (Table 1).

The amount of soluble and insoluble extractables after 1200 h at 80° C., the electrical conductivity, the total amount of extractable ions, the resistance to the coolant, and also the shock and burst at 110° C. were evaluated.

$$PA 11 = Rilan BESN P 123 Black TL ( Arkema )$$

Fluoropolymer: ETFE EP7000 (Daikin Chemicals)
PA9T: Genestar N1001D (Kuraray)
Binder 1: Orevac® 18342N (SK Functional Polymers)
Binder 2: Orevac® 18729 (SK Functional Polymers)

$$HDPE = Lupolen® 4261 AIM ( LyondellBasell ) \\ PP = SABIC® PP 4935 ( Sabic )$$

TPV: Santoprene® 101-87 (Exxonmobil)

TABLE 1

| | Electric | | |
|---|---|---|---|
| | conductivity | | |
| | after 168 h | Resistance | Bursting |
| | at 80° C. | to the | stress at |
| | μm/cm | coolant | 110° C. |
| CE1: Single-layer PA11 | 340 | A | 10 |
| E1: Single-layer HDPE | 8 | A | 3 |
| E2: Single-layer 9T | 15 | A | NT |
| E3: Single-layer PP | 20 | A | 6.5 |
| E4: Single-layer PPS | 11 | A | 9.5 |
| E5: Single-layer TPV | 23 | A | 4 |
| E6: PA11/binder 1/HDPE | 9 | A | 7.5 |
| 700 um/50 um/250 um | | | |
| E7: PA11/binder 2/PP | 22 | A | 8.5 |
| 700 um/50 um/250 um | | | |
| E8: PA11/fluoropolymer | 15 | A | 9.7 |
| 850 um/150 um | | | |
| E9: PA11/binder 2/TPV | 25 | A | 8 |
| 700 um/50 um/250 um | | | |

NT: not tested

Table 2 shows the tests used and the classification of the results.

TABLE 2

| | | Good (B) | Poor (C) |
|---|---|---|---|
| | Very good | or | or |
| Properties | (A) or low | medium | high |
| Electric conductivity after 168 h at 80° C. | <30 μS/cm | 30 to 200 | >200 |
| 6 lengths of 1 m of 8 × 1 mm tubes are rinsed | | μS/cm | μS/cm |
| twice and then filled with GM Dexcool coolant | | | |
| (~20 ml/tube). | | | |
| Each length is sealed by hot compression and | | | >50% |
| then placed in an oven for 168 hours at 80° C. | | | |
| After removal from the oven, the tubes are | | | |
| opened, emptied and the 6 amounts are | | | |
| collected (~120 ml/sample) and then | | | |
| measured in terms of pH & conductivity at | | | |
| 23° C. | | | |
| Aging in a coolant environment: a tube with | <20% | <40% | |
| dimensions of 8 × 1 mm (outer | | | |
| diameter × thickness) is kept in a chamber | | | |
| thermoregulated at 110° C. A glycol water | | | |
| solution produced from Havoline diluted to | | | |
| 50% by weight in water. The glycol water is | | | |
| heated to 110° C. and circulates in the tube. | | | |
| The aging state of the tube is analysed in terms | | | |
| of tension in comparison with the unaged tube | | | |
| (relative elongation loss). The half-life is | | | |
| obtained when the relative elongation is equal | | | |
| to −50%. | | | |

1. A single-layer or multilayer tubular structure for transporting a coolant, said tube being intended for fuel cell cooling, comprising at least one inner layer (I) comprising at least one thermoplastic polymer chosen from a polyolefin, a thermoplastic vulcanizate (TPV), a fluoropolymer, a polyphenylene sulfide (PPS) and a polyphthalamide (PPA), said coolant having a dielectric conductivity of less than 30 μS/cm, as determined after aging of said single-layer or multilayer tubular structure in contact with said coolant for 168 hours at 80° C.

2. The single-layer or multilayer tubular structure for transporting a coolant as claimed in claim 1, wherein it is single-layer.

3. The single-layer or multilayer tubular structure for transporting a coolant as claimed in claim 1, wherein it is multilayer and comprises an outer layer (II) comprising at least one thermoplastic polymer.

4. The single-layer or multilayer tubular structure as claimed in claim 1, wherein said thermoplastic polymer of the inner layer (I) is a polyolefin chosen from nonfunctionalized polyolefins, functionalized polyolefins and a mixture of these.

5. The single-layer or multilayer tubular structure as claimed in claim 1, wherein said polyolefin of the inner layer (I) is a nonfunctionalized polyolefin.

6. The single-layer or multilayer tubular structure as claimed in claim 5, wherein said nonfunctionalized polyolefin is chosen from a polyethylene and a polypropylene.

7. The multilayer tubular structure as claimed in claim 1, wherein said thermoplastic polymer of the inner layer (I) is a fluoropolymer.

8. The multilayer tubular structure as claimed in claim 1, wherein said thermoplastic polymer of the inner layer (I) is a polyphthalamide (PPA).

9. The multilayer tubular structure as claimed in claim 3, wherein the polyamide of the layer (II) is chosen from a semicrystalline aliphatic polyamide having a mean number of carbon atoms per nitrogen atom of from C4 to C15 and a semiaromatic polyamide (PPA).

10. The multilayer tubular structure as claimed in claim 9, wherein the polyamide of the layer (II) is a semicrystalline aliphatic polyamide that has a mean number of carbon atoms per nitrogen atom of from C8 to C15.

11. The multilayer tubular structure as claimed in claim 10, wherein the semicrystalline aliphatic polyamide is chosen from PA610, PA612, PA614, PA618, PA1010, PA1012, PA1014, PA1018, PA1210, PA1212, PA1214, PA1218, PA11 and PA12.

12. The multilayer tubular structure as claimed in claim 10, wherein the semicrystalline aliphatic polyamide is chosen from PA11 and PA12.

13. The multilayer tubular structure as claimed in claim 3, wherein the inner layer (I) has a thickness representing from 5% to 95% of the total thickness of said structure.

14. The multilayer tubular structure as claimed in claim 3, wherein the outer layer (II) has a thickness of at least 5% of the total thickness of said structure.

15. The multilayer tubular structure as claimed in claim 13, wherein the inner layer (I) has a thickness of from 5% to 95% of the total thickness of said structure and the outer layer (II) has a thickness of at least 5% of the total thickness of said structure.

16. The multilayer tubular structure as claimed in claim 3, wherein said tubular structure comprises a binder layer (III) located between said inner layer (I) and said outer layer (II).

17. The single-layer or multilayer tubular structure as claimed in claim 1, wherein said tubular structure has an amount of soluble and insoluble extractables released into said coolant of less than 1 g/m2, after aging of said multilayer tubular structure in contact with said coolant for 1200 hours at 80° C.

18. A method comprising using a tubular structure as defined in claim 1 for fuel cell cooling.
